(19) United States
(12) Patent Application Publication
(10) Pub. No.: US 2020/0343800 A1
(43) Pub. Date: Oct. 29, 2020

(54) ROTATION APPARATUS AND POWER GENERATION SYSTEM

(71) Applicant: SIMPLE TOKYO CO., LTD., Tokyo (JP)

(72) Inventors: Megumi Miyagawa, Nishitokyo-shi (JP); Keiko Kondo, Nishitokyo-shi (JP); Masaaki Miyagawa, Nishitokyo-shi (JP)

(73) Assignee: SIMPLE TOKYO CO., LTD., Tokyo (JP)

(21) Appl. No.: 16/924,480

(22) Filed: Jul. 9, 2020

Related U.S. Application Data
(63) Continuation of application No. PCT/JP2019/044299, filed on Nov. 12, 2019.

(30) Foreign Application Priority Data
Feb. 12, 2019 (JP) 2019-022274

(51) Int. Cl. H02K 21/14; H02K 11/22; H02K 49/10

(52) U.S. Cl. CPC H02K 21/14; H02K 49/102; H02K 11/22

(57) ABSTRACT

A rotation apparatus includes a first disk-shaped rotation body capable of rotating around a first rotation axis, a plurality of first permanent magnets arranged at a peripheral part of the first disk-shaped rotation body so that N-poles and S-poles thereof are distributed alternately, at least one pair of electromagnets arranged at static positions with a predetermined interval, and a pair of sensor switches for respectively detecting rotational positions of the N-poles and the S-poles of the plurality of first permanent magnets and for electrically energizing the at least one pair of electromagnets. One electromagnet of the pair of electromagnets is energized based on a detected result of the pair of sensor switches to move the first permanent magnet adjacent to the energized electromagnet, by an attractive force and a repulsive force between the energized electromagnet and the first permanent magnet so as to rotate the first disk-shaped rotation body.

### FIELD OF THE INVENTION

The present invention relates to a rotation apparatus for effectively producing a rotational moment by a magnetic force drive and a power generation system for generating electricity using the rotation apparatus.

### BACKGROUND ART

### Related Art Document

Conventionally, a magnetic force rotation apparatus using the repulsion force of permanent magnets is well-known. For example, a magnetic force repulsion motor described in Patent Document 1 circumferentially arranges a plurality of permanent magnets on a fixed member and a rotational member so as to produce a rotational force by using the magnetic repulsion force of the permanent magnets of the both members.

Also, in Patent Document 2, described is a magnetic force rotation apparatus configured by combining permanent magnets and electromagnets so as to produce a rotational torque for rotating rotation bodies by using the magnetic repulsion force of both the permanent magnets and the electromagnets.

That is, according to the magnetic force rotation apparatus described in Patent Document 2, first and second magnetic rotation bodies for producing rotatory power of the rotation axis are fixed with this axis pivotally, and first and second electromagnets energized in synchronization with the rotation of the rotation bodies are arranged to oppose to the first and second magnetic rotation bodies through a magnetic gap. The first and second electromagnets are fixed to a yoke that forms magnetic paths. Balancers made of a non-magnetic material for keeping balance of a plurality of board-shaped magnets that provide rotation power producing magnetic field and the rotation bodies are located on a disk of each of the first and second magnetic rotation bodies. Each board-shaped magnet is arranged to have a certain angle D with respect to the radius axis of the disk. A sensor for detecting the rotation position of the first and second magnetic rotation bodies is provided in one of these first and second magnetic rotation bodies. The first and second magnetic rotation bodies are energized when the lead board-shaped magnet in the rotating direction of the board-shaped magnets passes the detector. These first and second magnetic rotation bodies are de-energized when the rearmost board-shaped magnet in the rotating direction of the board-shaped magnets passes the detector.

### PATENT DOCUMENT

Patent Document 1: Japanese Patent Publication No. 2006-238596A

Patent Document 2: Japanese Patent No. 2968918B

### SUMMARY OF THE INVENTION

### Problem To Be Solved By The Invention

However, if the magnetic force rotation apparatus is formed only by the permanent magnets as described in Patent Document 1, the following problem may occur. That is, in case that the rotational side permanent magnet moved to separate from the fixed side permanent magnet, the magnetic repulsion force between these permanent magnets acted as driving force toward the front of the rotation direction, whereas in case that the rotational side permanent magnet moved to approach to the fixed side permanent magnet, the magnetic repulsion force between these permanent magnets acted as big resistive force to stop the driving force toward the front of the rotation direction. Due to the influence in magnetic force to act as the resistance of the driving force toward the front of the rotation direction, in practice, it was impossible to rotate the rotational side permanent magnet with respect to the fixed side permanent magnet.

The magnetic force rotation apparatus described in Patent Document 2 also has the following problems. That is, the constitution thereof was complicated because it was formed from not only permanent magnets and electromagnets but also rotation balancers, and because the apparatus utilized no torque of the rotation bodies, it was difficult to obtain necessarily enough energy efficiency.

The present invention intends to solve such problems, and the object of the present invention is to provide a rotation apparatus and a power generation system that can effectively maintain and utilize rotation energy by means of a simple constitution.

### Means To Solve The Problem

According to the present invention, a rotation apparatus includes a first disk-shaped rotation body capable of rotating around a first rotation axis, a plurality of first permanent magnets arranged at a peripheral part of the first disk-shaped rotation body so that N-poles and S-poles thereof are distributed alternately, at least one pair of electromagnets arranged at static positions with a predetermined interval, the static positions being near the plurality of first permanent magnets, and a pair of sensor switches for respectively detecting rotational positions of the N-poles and the S-poles of the plurality of first permanent magnets and for electrically energizing the at least one pair of electromagnets. One electromagnet of the pair of electromagnets is energized based on a detected result of the pair of sensor switches to move the first permanent magnet adjacent to the energized electromagnet in a predetermined direction, by an attractive force and a repulsive force between the energized electromagnet and the first permanent magnet so as to rotate the first disk-shaped rotation body.

A pair of electromagnets located at static positions in proximity to a plurality of first permanent magnets arranged at a peripheral part of the first disk-shaped rotation body are alternately energized in response to rotational positions of the N-poles and the S-poles of the permanent magnets. The permanent magnet moves in a predetermined direction by an attractive force and a repulsive force between the energized electromagnet and the permanent magnet so as to rotate the first disk-shaped rotation body. Thus, by means of the attractive force and the repulsive force between the energized electromagnet and the proximity permanent magnet, the first disk-shaped rotation body effectively rotates.

It is preferred that the apparatus further includes a pair of sensor perception boards arranged coaxially with the first disk-shaped rotation body. The pair of sensor perception boards have, on their outer circumferential end, convexo-concave portions arranged at positions that respectively correspond to positions of the N-poles and the S-poles of the plurality of first permanent magnets, side edges of the convexo-concave portions corresponding to front edges and rear edges of the N-poles or the S-poles. The pair of sensor perception boards are mounted on the first rotation axis to displace with each other by a predetermined angle in the rotation direction. According to this constitution, rotation energy can be effectively maintained and utilized, and also stable rotation can be obtained by means of a simple constitution.

It is also preferred that the at least one pair of electromagnets are arranged respectively at the positions corresponding to different poles of the plurality of first permanent magnets. Thus, an attractive force and a repulsive force of the permanent magnets can be used at the position of the N-pole and the S-pole.

It is further preferred that the pair of sensor switches has a first sensor circuit consisting of a first photo-sensor and a first switch for turning on/off a power supply path of a first electromagnet of the pair of electromagnets, and a second sensor circuit consisting of a second photo-sensor and a second switch for turning on/off a power supply path of a second electromagnet of the pair of electromagnets. The first sensor circuit is configured to detect, via a first sensor perception board arranged coaxially with the first disk-shaped rotation body, the positions of the front edges and the rear edges of the N-poles of the first permanent magnets, to energize the first electromagnet when the position of the front edge of the N-pole of the first permanent magnet is detected and to de-energize the first electromagnet when the position of the rear edge of the N-pole of the first permanent magnet is detected The second sensor circuit is configured to detect, via a second sensor perception board arranged coaxially with the first disk-shaped rotation body, the positions of the front edges and the rear edges of the S-poles of the first permanent magnets, to energize the second electromagnet when the position of the front edge of the S-pole of the first permanent, magnet is detected and to de-energize the second electromagnet when the position of the rear edge of the S-pole of the first permanent magnet is detected. Thus, more stable rotation can be obtained.

According to the present invention, a power generation system includes the aforementioned rotation apparatus, a power generator and a rotation transmission. The rotation transmission has an input shaft coupled with the first rotation axis of the rotation apparatus to be rotationally driven by the rotation apparatus and an output shaft coupled with the power generator to rotationally drive the power generator, for increasing a rotational speed of the output shaft than a rotational speed of the input shaft. According to this constitution, rotation energy can be effectively maintained and utilized by means of a simple constitution. Thus, efficient power accumulation can be expected.

It is preferred that the rotation transmission is integrated with the rotation apparatus.

It is also preferred that the rotation transmission includes a first magnetic gear mechanism having a second disk-shaped rotation body capable of rotating around a second rotation axis, and a plurality of second permanent magnets arranged at a peripheral part of the second disk-shaped rotation body so that N-poles and S-poles thereof are distributed alternately, and a second magnetic gear mechanism having a third disk-shaped rotation body capable of rotating around a third rotation axis, and a plurality of third permanent magnets arranged at a peripheral part of the third disk-shaped rotation foody so that N-poles and S-poles thereof are distributed alternately. The plurality of second permanent magnets of the first magnetic gear mechanism and the plurality of third permanent magnets of the second magnetic gear mechanism are arranged to close to each other so that the second magnetic gear mechanism rotates in a predetermined direction by means of an attractive force and a repulsive force between the plurality of second permanent magnets and the plurality of third permanent magnets when the first magnetic gear mechanism rotates. Thus, rotation energy can be effectively maintained and utilized by means of a simple constitution.

It is further preferred that a diameter of the second disk-shaped rotation body is larger than a diameter of the third disk-shaped rotation body, and that the third disk-shaped rotation body is arranged inside of the second disk-shaped rotation body.

It is still further preferred that the rotation transmission includes a third magnetic gear mechanism having a fourth disk-shaped rotation body capable of rotating around a fourth rotation axis, and a plurality of fourth permanent magnets arranged at a peripheral part of the fourth disk-shaped rotation body so that N-poles and S-poles thereof are distributed alternately. The third disk-shaped rotation body is arranged inside of the second disk-shaped rotation body. The plurality of third permanent magnets of the second magnetic gear mechanism and the plurality of fourth permanent magnets of the third magnetic gear mechanism are arranged to close to each other so that the third magnetic gear mechanism rotates in a predetermined direction by means of an attractive force and a repulsive force between the plurality of third permanent magnets and the plurality of fourth permanent magnets when the second magnetic gear mechanism rotates.

### Effect Of The Invention

According to the rotation apparatus of the present invention, a pair of electromagnets located at static positions in proximity to a plurality of first permanent magnets arranged at a peripheral part of the first disk-shaped rotation body are alternately energized in response to rotational positions of the N-poles and the S-poles of the permanent magnets. The permanent, magnet moves in a predetermined direction by an attractive force and a repulsive force between the energized electromagnet and the permanent magnet so as to rotate the first disk-shaped rotation body. Thus, by means of the attractive force and the repulsive force between the energized electromagnet and the proximity permanent magnet, the first disk-shaped rotation body effectively rotates. As a result, it is possible to effectively maintain and utilize rotation energy by means of a simple constitution.

According to the power generation system, the above-mentioned rotation apparatus is used. Also since the rotation transmission with non-contact magnetic gear mechanisms are used, there is no frictional resistance between the magnetic gear mechanisms and therefore the electrical power can be effectively generated using the rotational energy maintained effectively with little loss. As a result, the rotation energy can be effectively maintained and utilized by means of a simple constitution and thus efficient power accumulation can be expected.

### BRIEF DESCRIPTION OF DRAWINGS

FIG. 1 is a front view schematically illustrating a constitution of a rotation apparatus as an embodiment of the present invention;

FIG. 2 is a side view schematically illustrating a constitution of a main part of the rotation apparatus shown in FIG. 1;

FIG. 3 is a view schematically illustrating a constitution for detecting positions of N-poles and S-poles of the permanent magnet in the rotation apparatus shown in FIG. 1;

FIG. 4 is a view for describing rotational operations of the rotation apparatus shown in FIG. 1;

FIG. 5 is a view schematically illustrating a constitution of a power generation system provided with the rotation apparatus shown in FIG. 1;

FIG. 6 is a front view schematically illustrating a constitution of a main part of the power generation system shown in FIG. 5; and

FIG. 7 is a side view schematically illustrating a constitution of the main part of the power generation system shown in FIG. 5.

### DESCRIPTION OF THE PREFERRED EMBODIMENT

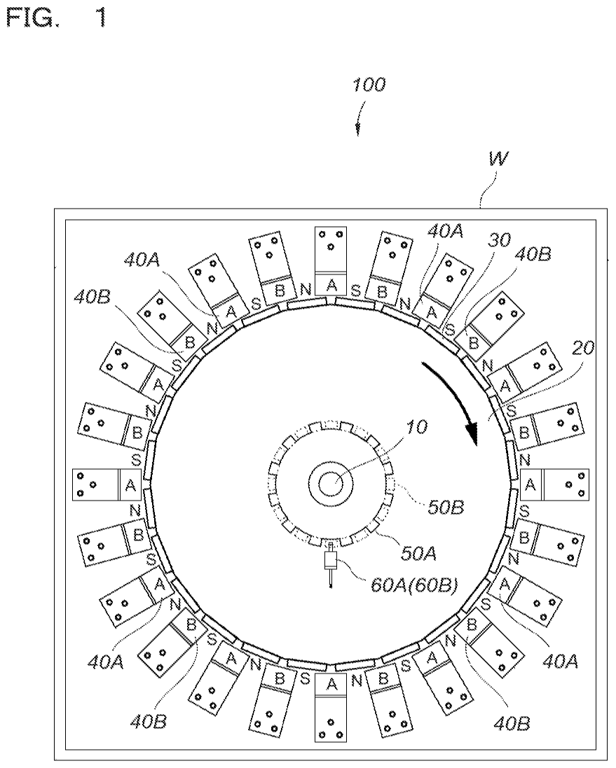

Hereinafter, an embodiment of the rotation apparatus and the power generation system according to the present invention will be described with reference to FIG. 1 to FIG. 7.

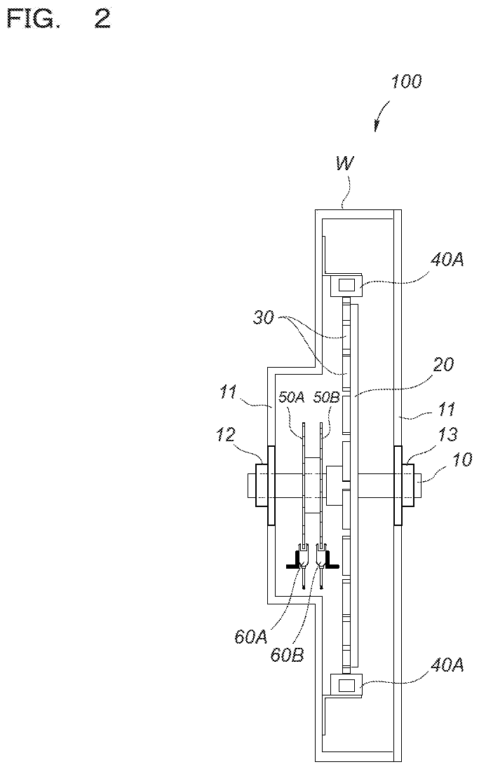

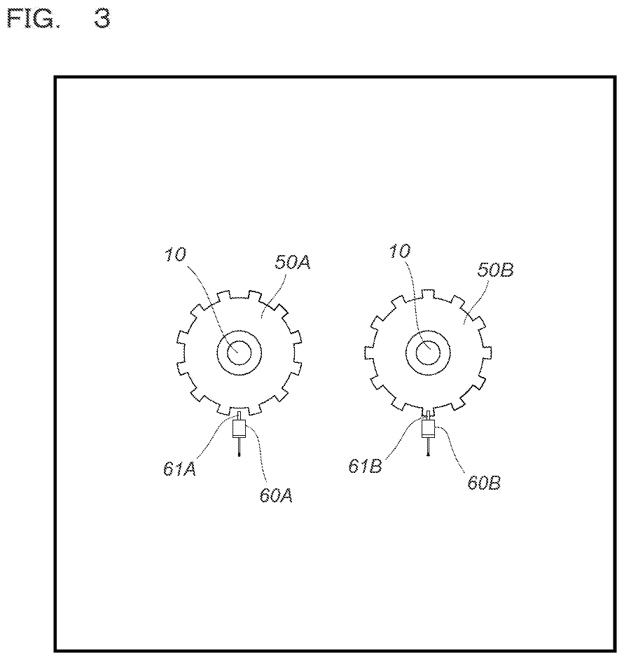

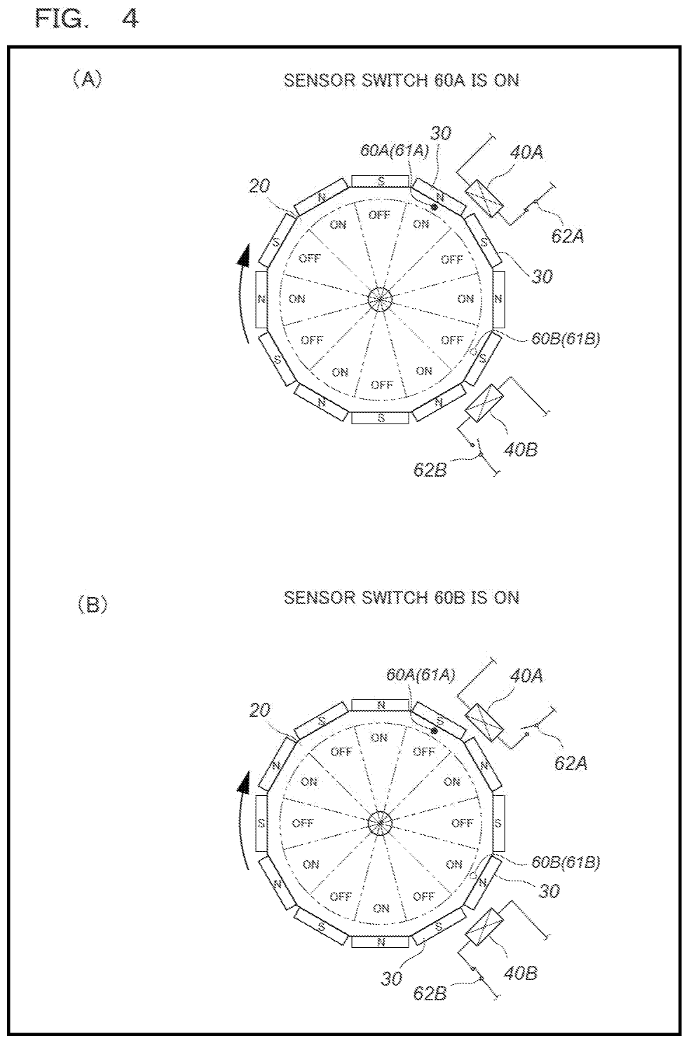

FIG. 1 schematically illustrates from the front a constitution of the rotation apparatus 100 as the embodiment of the present invention. In the figure, “A” indicates an electromagnet 40A, and “B” indicates an electromagnet 40B. FIG. 2 schematically illustrates from the side a constitution of the rotation apparatus 100 of this embodiment. FIG. 3 schematically illustrates a constitution of sensor switches 60A and 60B for detecting positions of N-poles and S-poles of the permanent magnet shows constitution and positional relationship of sensor perception board 50A of the present embodiment sensor perception boards 50A and 50B and sensor switch 60A and 60B. FIG. 4 describes rotational operations of the rotation apparatus 100 of this embodiment. In the figure, (A) indicates the conditions where the first electromagnet 40A is energized by the operation of the first sensor switch 60A, and (B) indicates the conditions where the second electromagnet 40B is energized by the operation of the second sensor switch 60B. Note that, in FIG. 1, in order to distinguish the sensor perception boards 50A and 50B, the sensor perception board 50A is shown by a solid line and the sensor perception board 50B is shown by a broken line.

As shown in FIG. 1 to FIG. 3, the rotation apparatus 100 in this embodiment is provided with a first rotation axis 10, a first disk-shaped rotation body 20 fixed to the first rotation axis 10 to be rotatable around this first rotation axis 10, a plurality of first permanent magnets 30 arranged at a peripheral part of the first disk-shaped rotation body 20 so that N-poles and S-poles thereof are distributed alternately, a plurality of pairs of electromagnets 40A and 40B arranged in a frame body W that is a fixed member (namely, arranged at static positions) with a predetermined interval, near the plurality of first permanent magnets 30, a pair of the sensor perception boards 50A and 50B arranged coaxially with the first disk-shaped rotation body 20, and a pair of the sensor switches 60A and 60B for respectively detecting rotation positions of the N-poles and the S-poles of the first permanent magnets 30 to alternately energize electrically the plurality of pairs of electromagnets 40A and 40B.

The first rotation axis 10 is configured by, for example, a steel rotation shaft, and supported by bearings 12 and 13 fixed to respectively sidewalls 11 of the frame body W to smoothly rotate.

The first disk-shaped rotation body 20 is coaxially fixed to the first rotation axis 10. In this embodiment, the plurality of first permanent magnets 30 (twenty-four first permanent magnets 30) are arranged with a predetermined interval at a peripheral part of the first disk-shaped rotation body 20 so that their poles are distributed alternately.

As for the first permanent magnet 30, a stick-shaped neodymium magnet is used, for example. In this embodiment, each of the plurality of (twenty-four) first permanent magnets 30 is shaped in for example a rectangular parallelepiped shape. Two opposed side faces of the rectangular parallelepiped shape configure magnetic faces of the N-pole and the S-pole, respectively. These plurality of first permanent magnets 30 are arranged as aforementioned so that polarities of the magnetic poles become the alternation at the peripheral part of the first disk-shaped rotation body 20. Thus, it is possible to form magnetic flows between the N-pole and S-pole permanent magnets 30. It should be noted that the shape of the permanent magnets 30 is not limited to the rectangular parallelepiped shape.

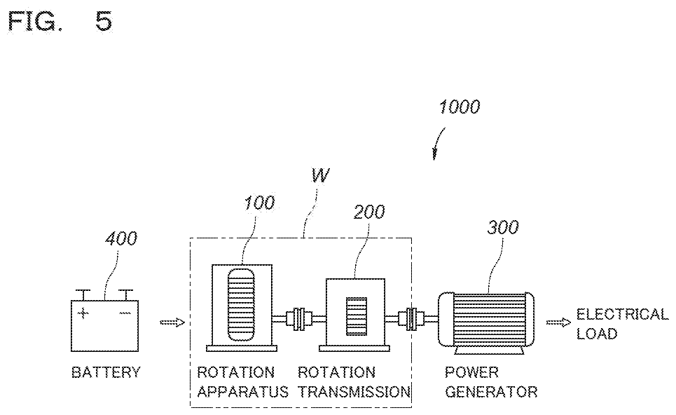

The electromagnets 40A and 40B are configured by winding coils around iron cores. As is well-known, when electrical current flows through the coil, magnetic flux and magnetic field will be produced through the iron core. Polarity of the iron core becomes N-pole or S-pole in accordance with the winding direction (or current direction) of the coil. Although it is not shown, the electromagnets 40A and 40B in this embodiment are connected to a power source as a battery 400 (FIG. 5) and electrical power from this power source is on/off controlled by means of a first switch 62A and a second switch 62B of the respective sensor switches 60A and 60B. In this embodiment, the plurality of (twenty-four) electromagnets 40A and 40B are arranged at static positions outside of the peripheral of the first disk-shaped rotation body 20 with a predetermine interval. That is, 12 electromagnets 40A and 12 electromagnets 40B are mounted as for the electromagnets 40A and 40B. These electromagnets 40A and 40B are located in proximity to the first permanent magnets 30, respectively.

The pair of sensor perception board 50A and 50B are provided with (twelve) convexo-concave portions at their outer circumferential ends arranged at positions that respectively correspond to positions of the N-poles and the S-poles of the first permanent magnets 30. Rotational positions of side edges of the convexo-concave portions correspond to rotational positions of front edges and rear edges of the N-poles or the S-poles, respectively. These pair of sensor perception board 50A and 50B are mounted on the first rotation axis 10 to displace with each other by a predetermined angle (an angle corresponding to one first permanent magnet 30 for example) in the rotation direction, and rotate together with the first disk-shaped rotation body 20.

The pair of sensor switches 60A and 60B are provided with a first sensor circuit consisting of a first photo-sensor 61A and a first switch 62A for turning on/off power supply paths of the first electromagnets 40A, and a second sensor circuit consisting of a second photo-sensor 61B and a second switch 62B for turning on/off power supply paths of the second electromagnets 40B. The first sensor circuit detects, via the first sensor perception board 50A arranged coaxially with the first disk-shaped rotation body 20, the positions of the front edges and the rear edges of the N-poles of the first permanent magnets 30, to turn on the first switch 62A so as to energize the first electromagnet 40A when the position of the front edge of the N-pole of the first permanent magnet 30 is detected and to turn off the first switch 62A so as to de-energize the first electromagnet 40A when the position of the rear edge of the N-pole of the first permanent magnet 30 is detected. The second sensor circuit detects, via the second sensor perception board 50B arranged coaxially with the first disk-shaped rotation body 20, the positions of the front edges and the rear edges of the S-poles of the first permanent magnets 30, to turn on the second switch 62B so as to energize the second electromagnet 40B when the position of the front edge of the S-pole of the first permanent magnet 30 is detected and to turn off the second switch 62B so as to de-energize the second electromagnet 40B when the position of the rear edge of the S-pole of the first permanent magnet 30 is detected.

Next, rotational operations of the rotation apparatus 100 of this embodiment will be described with reference to FIG. 4.

The sensor switch 60A detects the positions of the front edge and the rear edge of the N-pole of the first permanent magnet 30 through the first sensor perception board 50A arranged coaxially with the first disk-shaped rotation body 20. When the position of the front edge of the N-pole of the first permanent magnet 30 is detected, the first switch 62A is turned on and the first electromagnet 40A is energized and excited as shown in FIG. 4(A). Thus, an attractive force with respect to the N-pole of the first permanent magnet 30 at the peripheral part of the first disk-shaped rotation body 20 and a repulsive force with respect to the S-pole of the first permanent magnet 30 at the peripheral part of the first disk-shaped rotation body 20 are produced so as to rotate the first disk-shaped rotation body 20 in the direction of the arrow. When the position of the rear edge of the N-pole of the first permanent magnet 30 is detected, the first switch 62A is turned off and the first electromagnet 40A is de-energized. On the other hand, the sensor switch 60B detects the positions of the front edge and the rear edge of the S-pole of the first permanent magnet 30 through the second sensor perception board 50B arranged coaxially with the first disk-shaped rotation body 20. When the position of the front edge of the S-pole of the first permanent magnet 30 is detected, the second switch 62B is turned on and the second electromagnet 40B is energized and excited as shown in FIG. 4(B). Thus, an attractive force with respect to the S-pole of the first permanent magnet 30 at the peripheral part of the first disk-shaped rotation body 20 and a repulsive force with respect to the N-pole of the first permanent magnet 30 at the peripheral part of the first disk-shaped rotation body 20 are produced so as to rotate the first disk-shaped rotation body 20 in the direction of the arrow. When the position of the rear edge of the S-pole of the first permanent magnet 30 is detected, the second switch 62B is turned off and the second electromagnet 40B is de-energized. By alternately energizing the first electromagnet 40A and the second electromagnet 40B, the first disk-shaped rotation body 20 rotates in the direction of the arrow shown in FIGS. 4(A) and 4(B) . In case that the apparatus has a plurality of pairs of the electromagnets 40A and 40B, by alternately energizing the plurality of electromagnet 40A and the plurality of electromagnet 40B similarly as the above explanation, bigger attractive force and bigger repulsive force can be produced.

As described above in detail, according to the rotation apparatus 100 of this embodiment, since the plurality of electromagnets 40A and the plurality of electromagnets 40B are alternately energized, it is possible to produce the attractive force and the repulsive force between the electromagnets 40A and 40B and the first permanent magnets 30 to rotate the first disk-shaped rotation body 20. Thus, it is possible to effectively maintain and utilize rotation energy by means of a simple constitution. Also, it is possible to obtain more stable rotation.

Furthermore, according to the rotation apparatus 100 of this embodiment, since the plurality of pairs of electromagnets 40A and 40B are arranged respectively at the positions corresponding to different poles of the plurality of first permanent magnets 30. Thus, an attractive force and a repulsive force of the permanent magnets 30 can be used at the position of the N-pole and the S-pole.

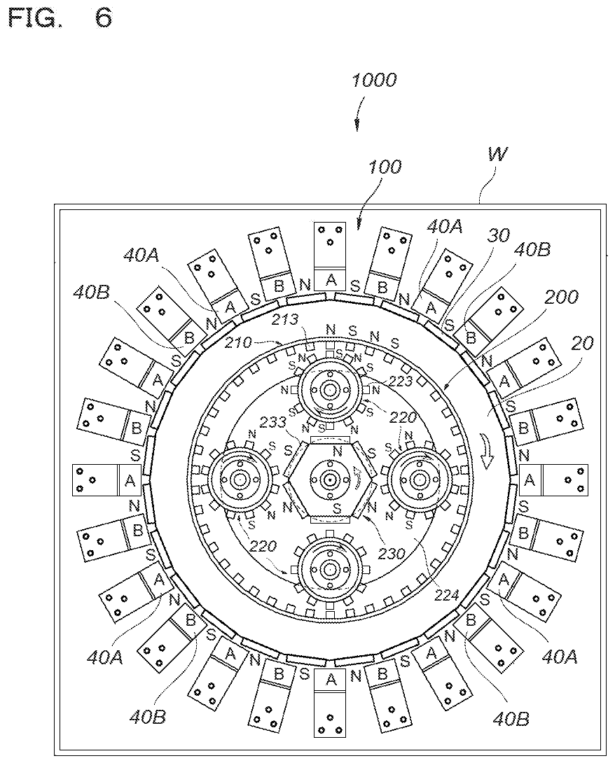

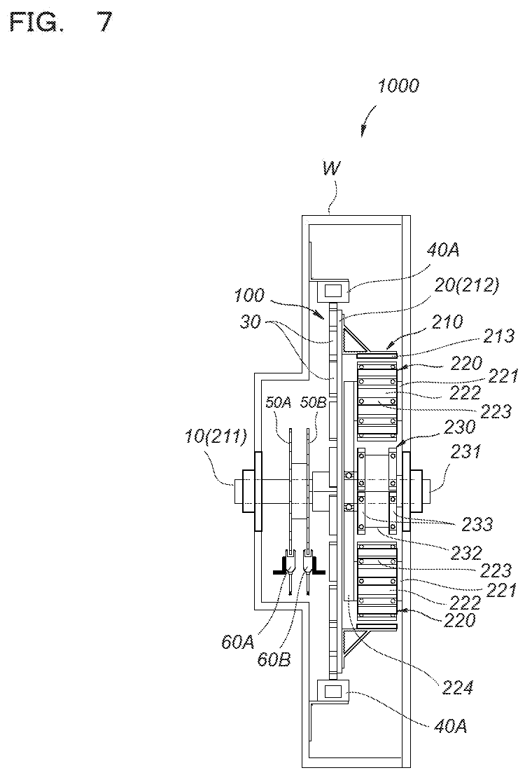

FIG. 5 schematically illustrates a constitution of a power generation system 1000 provided with the rotation apparatus 100 of this embodiment, FIG. 6 schematically illustrates a constitution of a main part of the power generation system 1000 seen from the front, and FIG. 7 schematically illustrates a constitution of the main part of the power generation system 1000 seen from the side.

The power generation system 1000 of this embodiment is provided with, as shown in FIG. 5, the rotation apparatus 100, a rotation transmission 200, a power generator 300 and a battery 400 that is a power supply for supplying electricity to the rotation apparatus 100. The rotation transmission 200 has an input shaft coupled with the first rotation axis 10 of the rotation apparatus 100 to be rotationally driven by the rotation apparatus 100 and an output shaft coupled with the power generator 300 to rotationally drive the generator 300. This rotation transmission 200 has functions to increase the rotational speed of the output shaft upper than the rotational speed of the input shaft. Also, as shown in FIGS. 6 and 7, in this embodiment, the rotation apparatus 100 and the rotation transmission 200 are integrated together and housed in a frame body W.

An electrical circuit (not shown) for supplying electricity from the power supply such as the battery 400 to the electromagnets 40A and 40B and to the sensor switches 60A and 60B is connected.

The rotation transmission 200 includes a first magnetic force gear mechanism 210, four second magnetic force gear mechanisms 220 and a third magnetic force gear mechanism 230. The first magnetic force gear mechanism 210 has a second disk-shaped rotation body 212 capable of rotating around a second rotation axis 211 and a plurality of (forty-two) of second permanent magnets 213 located at a peripheral part of this second disk-shaped rotation body 212 so that N-poles and S-poles of the second permanent magnets 213 are alternately distributed.

In this embodiment, the first rotation axis 10 and the first disk-shaped rotation body 20 of the rotation apparatus 100 are sheared as the second rotation axis 211 and the second disk-shaped rotation body 212. That is, the first rotation axis 10 of the rotation apparatus 100 functions for the second rotation axis 211, and the first disk-shaped rotation body 20 of the rotation apparatus 100 partially functions for the second disk-shaped rotation body 212. The plurality of first permanent magnets 30 are located at the peripheral part on one surface of the first disk-shaped rotation body 20 (the second disk-shaped rotation body 212), and the plurality of second permanent magnets 213 are located at the peripheral part on the other surface of the first disk-shaped rotation body 20 (the second disk-shaped rotation body 212). Each of the four second magnetic force gear mechanisms 220 has a third disk-shaped rotation body 222 capable of rotating around a third rotation axis 221 and a plurality of (twelve) third permanent magnets 223 located at a peripheral part of this third disk-shaped rotation body 222 so that N-poles and S-poles of the third permanent magnets 223 are alternately distributed. Also, the second disk-shaped rotation body 212 has a diameter different from that of the third disk-shaped rotation body 222. For example, the diameter of the second disk-shaped rotation body 212 is bigger than the diameter of the third disk-shaped rotation body 222. The second disk-shaped rotation body 212 has the plurality of second permanent magnets 213 with the number different from that of the third permanent magnets 223 of the third disk-shaped rotation body 222. For example, forty-two second permanent magnets 213 are arranged on the second disk-shaped rotation body 212. Even more particularly, the third disk-shaped rotation foody 222 is arranged inside of the second disk-shaped rotation body 212. The four second magnetic force gear mechanisms 220 are mounted on a rotational plate member 224 capable rotating with respect to the second disk-shaped rotation body 212. When the first magnetic force gear mechanism 210 rotates in response to the rotation of the rotation apparatus 100, the second magnetic force gear mechanisms 220 rotate in a predetermined direction (the same direction in this case) due to the attractive force and the repulsive force between the permanent magnets of the first magnetic force gear mechanism 210 and the permanent magnets of the second magnetic force gear mechanisms 220. The third magnetic force gear mechanism 230 has a fourth disk-shaped rotation body 232 capable of rotating around a fourth rotation axis 231 and a plurality of (six) fourth permanent magnets 233 located at a peripheral part of this fourth disk-shaped rotation body 232 so that N-poles and S-poles of the fourth permanent magnets 233 are alternately distributed. The fourth disk-shaped rotation body 232 has a diameter different from that of the second disk-shaped rotation body 212 and the third disk-shaped rotation body 222. For example, the diameter of the fourth disk-shaped rotation body 232 is smaller than the diameter of the second disk-shaped rotation body 212 and bigger than the diameter of the third disk-shaped rotation body 222. The fourth disk-shaped rotation body 232 has the plurality of fourth permanent magnets 233 with the number different from that of the third permanent magnets 223 of the third disk-shaped rotation body 222. For example, six fourth permanent magnets 233 are arranged on the fourth disk-shaped rotation body 232. When the second magnetic force gear mechanisms 220 rotate, the third magnetic force gear mechanism 230 rotates in a predetermined direction (the opposite direction in this case) due to the attractive force and the repulsive force between the permanent magnets of the second magnetic force gear mechanisms 220 and the permanent magnets of the third magnetic force gear mechanism 230. In this embodiment, the fourth rotation axis 231 is the output shaft connected to the input shaft of the generator 300.

The generator 300 in this embodiment is a device for converting a rotational energy into an electrical energy using the electromagnetic induction operations and a commercially available generator can be used as for the generator 300. The input shaft of the generator 300 is coupled with the output shaft (the fourth rotation axis 231) of the rotation transmission 200.

As described above in detail, the power generation system 1000 of this embodiment includes the rotation apparatus 100, the rotation transmission 200 coupled with the first rotation axis 10 of the rotation apparatus 100, and the power generator 300 coupled with the output shaft 231 of the rotation transmission 200. According to the power generation system of this embodiment, since there is no frictional resistance between the magnetic force gear mechanisms of the rotation transmission 200, loss in energy is extremely little. Thus, output energy can be efficiently taken out to generate electricity. As a result, it is possible to effectively maintain and utilize rotation energy by means of a simple constitution and thus efficient power accumulation can be expected. Also, a space-saving effect can be expected by integrating the rotation apparatus 100 and the rotation transmission 200. Furthermore, the conductivity of the rotation torque can be increased by increasing magnetic force of the first permanent magnets 30. Even more particularly, due to the non-contact operations of the magnetic force gear mechanisms of the rotation transmission 200, when the rotational speed increases, inertia force will act on the magnetic force gear mechanisms to rotate them smoothly.

In the aforementioned embodiment of the rotation apparatus 100, the plurality pairs of electromagnets 40A and 40B are provided outside of the peripheral of the first disk-shaped rotation body 20 at the peripheral part of which the plurality of first permanent magnets 30 are arranged. However, the rotation apparatus according to the present invention is not limited to this example. One pair of electromagnets 40A and 40B may be provided outside of the peripheral of the first disk-shaped rotation body 20.

Also, the number of the first permanent magnets, the number of the second permanent magnets and the number of the sensors in the rotation apparatus 100 are a simple example, and the present invention is not limited to these numbers. For example, these numbers may be changed depending on the size of the apparatus or on the performance of the magnet.

Further, in the rotation apparatus 100 of the aforementioned embodiment, the photo-sensors are used as for the sensor switches 60A and 60B. However, the present invention is not limited to this.

Still further, the rotation transmission 200 of the aforementioned embodiment is configured by a two-stage shifting mechanism with the first magnetic force gear mechanism 210, the second magnetic force gear mechanism 220 and the third magnetic force gear mechanism 230. However, the present invention is not limited to this. Depending upon the desired output speed, one-stage shifting mechanism, or three or more-stage shifting mechanism may be used.

Even more particularly, although the rotation transmission 200 of the aforementioned embodiment uses the magnetic force rotation transmission with the first magnetic force gear mechanism 210, the second magnetic force gear mechanism 220 and the third magnetic force gear mechanism 230, the present invention is not limited to this. Other rotation transmissions using non-magnetic force may be used.

Many widely different embodiments of the present invention may be constructed without departing from the spirit and scope of the present invention. It should be understood that the present invention is not limited to the specific embodiments described in the specification, except as defined in the appended claims.

1. A rotation apparatus comprising:
a first disk-shaped rotation body capable of rotating around a first rotation axis;
a plurality of first permanent magnets arranged at a peripheral part of said first disk-shaped rotation body so that N-poles and S-poles thereof are distributed alternately;
at least one pair of electromagnets arranged at static positions with a predetermined interval, said static positions being near the plurality of first permanent magnets;
a pair of sensor perception boards arranged coaxially with said first disk-shaped rotation body; and
a pair of sensor switches for respectively detecting rotational positions of the N-poles and the S-poles of the plurality of first permanent magnets and for electrically energizing the at least one pair of electromagnets,
the pair of sensor perception, boards having, on their outer circumferential end, convexo-concave portions arranged at positions that respectively correspond to positions of the N-poles and the S-poles of the plurality of first permanent magnets, side edges of said convexo-concave portions corresponding to front edges and rear edges of the N-poles or the S-poles, the pair of sensor perception boards being mounted on said first rotation axis to displace with each other by a predetermined angle in the rotation direction,
one electromagnet of the pair of electromagnets being energized based on the result of the pair of sensor switches, detected via the pair of sensor perception boards, to move said first permanent magnet adjacent to the energized electromagnet in a predetermined direction, by an attractive force and a repulsive force between the energized electromagnet and the first permanent magnet so as to rotate said first disk-shaped rotation body.

2. The rotation apparatus as claimed in claim 1, wherein the at least one pair of electromagnets are arranged respectively at the positions corresponding to different poles of the plurality of first permanent magnets.

3. The rotation apparatus as claimed in claim 1, wherein the pair of sensor switches has a first sensor circuit consisting of a first photo-sensor and a first switch for turning on/off a power supply path of a first electromagnet of the pair of electromagnets, and a second sensor circuit consisting of a second photo-sensor and a second switch for turning on/off a power supply path of a second electromagnet of the pair of electromagnets, wherein said first sensor circuit is configured to detect, via a first sensor perception board arranged coaxially with said first disk-shaped rotation body, the positions of the front edges and the rear edges of the N-poles of the first permanent magnets, to energize said first electromagnet when the position of the front edge of the N-pole of the first permanent magnet is detected and to de-energize said first electromagnet when the position of the rear edge of the N-pole of the first permanent magnet is detected, and wherein said second sensor circuit is configured to detect, via a second sensor perception board arranged coaxially with said first disk-shaped rotation body, the positions of the front edges and the rear edges of the S-poles of the first permanent magnets, to energize said second electromagnet when the position of the front edge of the S-pole of the first permanent magnet is detected and to de-energize said second electromagnet when the position of the rear edge of the S-pole of the first permanent magnet is detected.

4. A power generation system comprising a rotation apparatus as claimed in claim 1, a power generator, and a rotation transmission having an input shaft coupled with said first rotation axis of said rotation apparatus to be rotationally driven by said rotation apparatus and an output shaft coupled with said power generator to rotationally drive said power generator, for increasing a rotational speed of said output shaft than a rotational speed of said input shaft, said rotation transmission being integrated with said rotation apparatus.

5. The power generation system as claimed in claim 4, wherein said rotation transmission comprises a first magnetic gear mechanism having a second disk-shaped rotation body capable of rotating around a second rotation axis, and a plurality of second permanent magnets arranged at a peripheral part of said second disk-shaped rotation body so that N-poles and S-poles thereof are distributed alternately; and a second magnetic gear mechanism having a third disk-shaped rotation body capable of rotating around a third rotation axis, and a plurality of third permanent magnets arranged at a peripheral part of said third disk-shaped rotation body so that N-poles and S-poles thereof are distributed alternately, and wherein the plurality of second permanent magnets of said first magnetic gear mechanism and the plurality of third permanent magnets of said second magnetic gear mechanism are arranged to close to each other so that said second magnetic gear mechanism rotates in a predetermined direction by means of an attractive force and a repulsive force between the plurality of second permanent magnets and the plurality of third permanent magnets when said first magnetic gear mechanism rotates.

6. The power generation system as claimed in claim 5, wherein a diameter of said second disk-shaped rotation body is larger than a diameter of said third disk-shaped rotation body, and wherein said third disk-shaped rotation body is arranged inside of said second disk-shaped rotation body.

7. The power generation system as claimed in claim 5, wherein said rotation transmission comprises a third magnetic gear mechanism having a fourth disk-shaped rotation body capable of rotating around a fourth rotation axis, and a plurality of fourth permanent magnets arranged at a peripheral part of said fourth disk-shaped rotation body so that N-poles and S-poles thereof are distributed alternately, wherein said third disk-shaped rotation body is arranged inside of said second disk-shaped rotation body, and wherein the plurality of third permanent magnets of said second magnetic gear mechanism and the plurality of fourth permanent magnets of said third magnetic gear mechanism are arranged to close to each other so that said third magnetic gear mechanism rotates in a predetermined direction by means of an attractive force and a repulsive force between the plurality of third permanent magnets and the plurality of fourth permanent magnets when said second magnetic gear mechanism rotates.
